(19) United States
(12) Patent Application Publication
(10) Pub. No.: US 2002/0198772 A1
(43) Pub. Date: Dec. 26, 2002

(54) Encouraging house card use through price guarantees

(76) Inventors: Cary Lee Bates, Rochester, MN (US); Mahdad Majd, Rochester, MN (US); John Matthew Santosuosso, Rochester, MN (US)

Correspondence Address: Gero G. McClellan, Thomason, Moser & Patterson, L.L.P., Suite 1500, 3040 Post Oak Boulevard, Houston, TX, 77056-6582, US

(21) Appl. No.: 09/887,621

(22) Filed: Jun. 22, 2001

(51) Int. Cl. G06F 17/60

(52) U.S. Cl. 705/14; 705/20; 705/1

(57) ABSTRACT

Method, signal bearing medium and apparatus for price-guaranteeing an item purchased by a customer. One embodiment provides a method for price-guaranteeing an item purchased by a customer, comprising: receiving, by a central computer system, transaction data from a cash register computer system, the transaction data including an item identification number and an item purchase price; comparing the item purchase price to at least one of an item current price and an item match price; and if the item purchase price is higher than at least one of an item current price and an item match price, crediting an amount to a credit card account of the customer.

### RELATED APPLICATIONS

This patent application is related to the following patent application which is filed concurrently herewith and is hereby incorporated by reference: U.S. patent application Ser. No. ROC920010092 entitled “BUSINESS METHOD FOR CREDIT CARD EMAIL ALERTS”, having Ser. No. ______.

### BACKGROUND OF THE INVENTION

1. Field of the Invention

The present invention generally relates to a computer implemented method for price-guaranteeing an item purchased by a customer, and more particularly, for price-guaranteeing items purchased using a department store credit card.

2. Description of the Related Art

Many department stores offer department store credit cards which provide convenience for the department store customers. To promote the department store credit cards and to encourage purchases using department store credit cards, the department stores may offer direct discounts and/or discount coupons for signing up and using the department store credit card for purchases. In return, the department store hopes to profit from interest accrued for unpaid balances in the department store credit card accounts. However, many customers do not apply for or use department store credit cards for purchases because of competitive practices from other credit card companies, such as cash rebates, gifts, and/or discounts. Therefore, department store credit cards need additional promotions to compete against general credit cards.

Many stores have price guarantee policies which allow their customers to obtain refunds or store credits for previously purchased items that go on sale within a designated time period (e.g., 30 days) after the date of purchase. Generally, each customer must keep track of the purchased items and prices, as well as when the price of the purchased items had been reduced. When the previously purchased items go on sale at a later date, the customer must remember that the items were previously purchased at a higher price and bring back the sales receipt to the store to obtain the refund or credit. Typically, the customers are unable to keep track and/or remember the purchased items and the purchased price, and thus, the customers usually do not request refunds or credits for purchased items that went on sale, even though the customers are entitled to the refund or credit.

Therefore, a need exists for a computer implemented method for price-guaranteeing an item purchased by a customer, particularly for items purchased using a department store credit card.

### SUMMARY OF THE INVENTION

Embodiments of the present invention generally provide methods, signal bearing media and apparatus for price-guaranteeing an item purchased by a customer. In one aspect, embodiments of the present invention provide methods, signal bearing media and apparatus for price-guaranteeing items purchased using a department store credit card.

One embodiment provides a method for price-guaranteeing an item purchased by a customer, comprising: receiving, by a central computer system, transaction data from a cash register computer system, the transaction data including an item identification number and an item purchase price; comparing the item purchase price to a comparison price comprising at least one of an item current price and an item match price; and if the item purchase price is higher than the comparison price, crediting an amount to a credit card account of the customer.

Another embodiment provides a signal bearing medium, comprising a program which, when executed by a processor, performs a method for price-guaranteeing an item purchased by a customer, the method comprising: receiving, by a central computer system, transaction data from a cash register computer system, the transaction data including an item identification number and an item purchase price; comparing the item purchase price to a comparison price comprising at least one of an item current price and an item match price; and if the item purchase price is higher than the comparison price, crediting an amount to a credit card account of the customer.

Another embodiment provides a system for price-guaranteeing an item purchased by a customer comprising a central computer system having a processor, a memory and one or more storage devices for storing data connected to the processor, wherein the processor is configured to: receive transaction data from a cash register computer system, the transaction data including an item identification number and an item purchase price; compare the item purchase price to a comparison price comprising at least one of an item current price and an item match price; and if the item purchase price is higher than the comparison price, credit an amount to a credit card account of the customer.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a schematic diagram illustrating one embodiment of a network environment 100 for performing price guarantees for items purchased by a credit card customer.

FIG. 2 illustrates one embodiment of a customer table 200 containing customer records.

FIG. 3 illustrates one embodiment of a customer transaction table 300 containing customer transaction records.

FIG. 4 illustrates one embodiment of an item information table 400 containing item information records.

FIG. 5 illustrates one embodiment of a customer credit table 500 containing customer credit records.

FIG. 6 illustrates one embodiment of a store table 600 containing store description records.

FIG. 7 is a flow diagram illustrating a method 700 for handling purchases at a cash register.

FIG. 8 is a flow diagram illustrating a method 800 for updating and adding records to the store description table 600 and the item information table 400.

FIG. 9 is a flow diagram illustrating a method 900 for determining whether any scanner errors occurred for items purchased by customers using the department store credit card.

FIG. 10 is a flow diagram illustrating a method 1000 for determining price guarantee credits for items purchased by customers using the department store credit card.

### DETAILED DESCRIPTION OF THE PREFERRED EMBODIMENT

Embodiments of the present invention generally provide methods, signal bearing media and apparatus for price-guaranteeing an item purchased by a customer. In one aspect, embodiments of the present invention provide methods, signal bearing media and apparatus for price-guaranteeing an item purchased using a department store credit card.

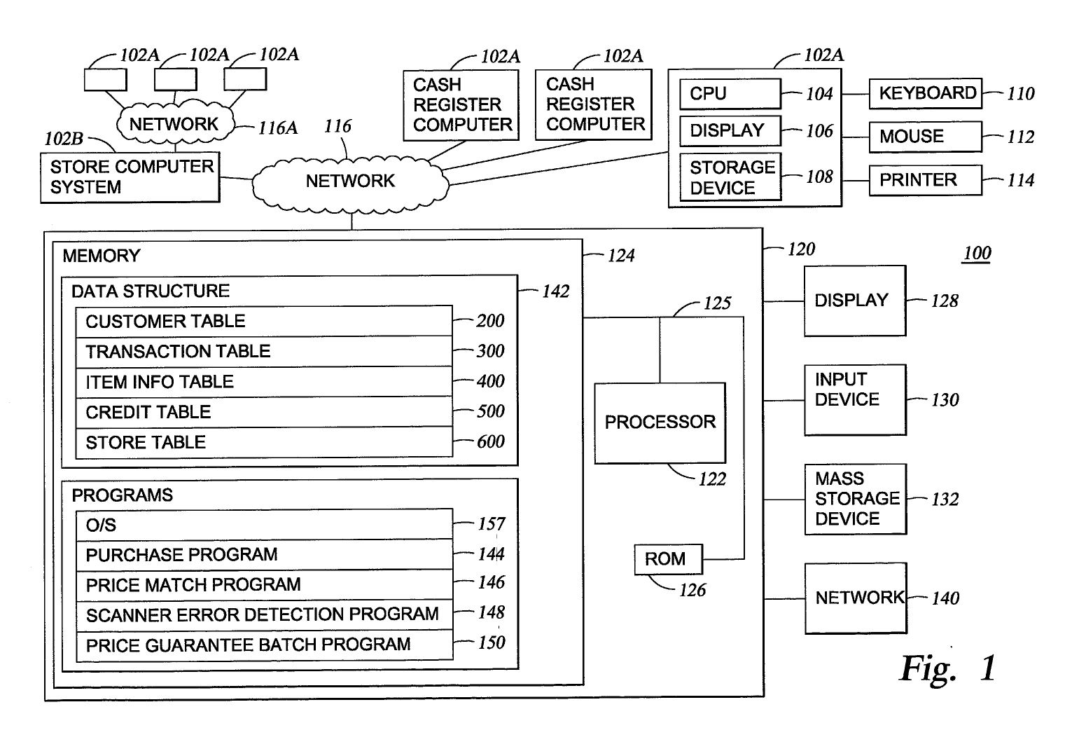

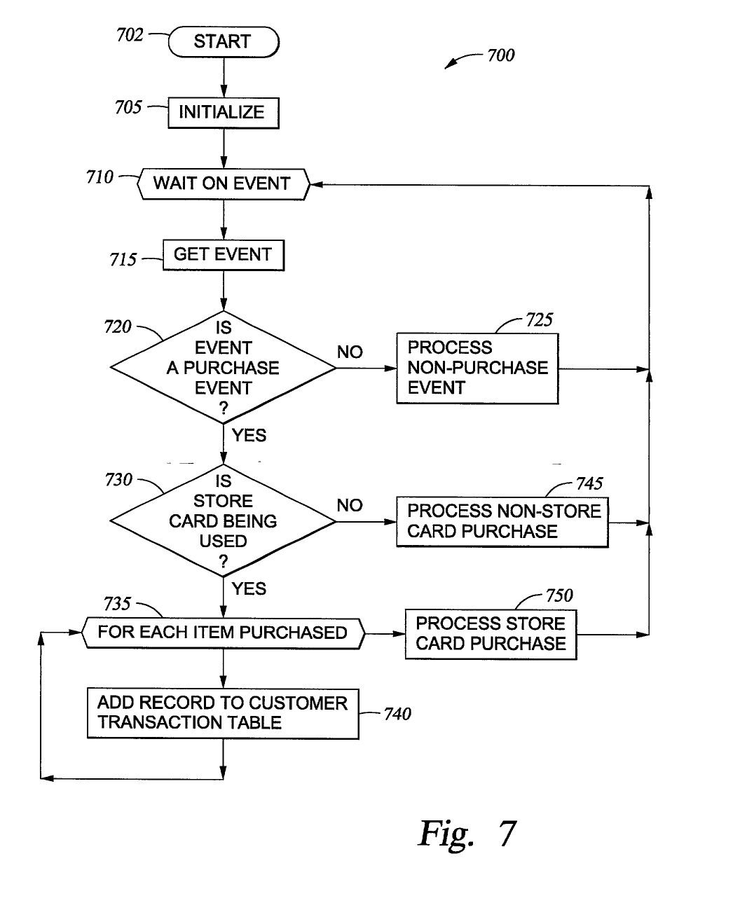

One embodiment of the invention is implemented as a program product for use with a computer system such as, for example, the network environment 100 shown in FIG. 1 and described below. The program(s) of the program product defines functions of the embodiments (including the methods described below with reference to FIGS. 7-10) and can be contained on a variety of signal bearing media. Illustrative signal bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 is a schematic diagram illustrating one embodiment of a network environment 100 for performing price guarantees for items purchased by a credit card customer. The network environment 100 includes central control system 120 and a plurality of input systems 102A-B. Illustratively, the input systems 102A-B may include a plurality of cash register computers 102A that are connected through a network 116 to the central control system 120. The input systems 102A-B may also include one or more store computer systems 102B connected through a store network 116 to the central control system 120. Each store computer system 102B may include a store central system and a plurality of cash register computers 102A connected through the store network 116A to the store central computer system 102B. For example, in one embodiment, each store in a chain of department stores may include a store computer system 102B and a plurality of cash register computers 102A, and each store computer system 102B is connected to the central control system 120. As another example, in another embodiment, a plurality of cash register computers 102A are grouped and assigned to each store in a chain of department stores, and the pluralities of cash register computers 102A are connected to the central control system 120. Although embodiments of the invention are described in relation to department store credit cards, other embodiments are contemplated for applications involving purchases using credit cards in general and other forms of electronic payment systems, such as direct-debit cards, check cards, and ATM cards.

Each cash register computer 102A may include a central processing unit (CPU) 104, a number of peripheral components, such as a computer display 106, a storage device 108, a printer 114, and various input devices (e.g., keyboard 110 and mouse 112). The network 116 may represent any type of local area network, wide area network, and public networks (e.g., the Internet). Moreover, any number of computers, networked systems and other devices may be networked through network 116 to connect to the central control system 120.

The central control system 120 may represent any type of computer, computer system or other programmable electronic device, including a server computer, a client computer (e.g., input systems 102A-B), a portable computer, a handheld computer, an embedded controller, a network of computers, etc. The central control system 120 illustratively includes at least one processor 122 coupled to memory 124 and read only memory (ROM) 126 via a bus 125. Processor 122 may represent one or more processors (e.g., microprocessors), and memory 124 may represent the random access memory (RAM) devices, comprising the main storage of the central control system 120, as well as any supplemental levels of memory, e.g., cache memories, nonvolatile or backup memories (e.g., programmable or flash memories), read only memories, etc. In addition, memory 124 may be considered to include memory storage physically located elsewhere in central control system 120, e.g., any cache memory in processor 122, as well as any storage capacity used as a virtual memory, e.g., as stored on a mass storage device 132 or on another computer coupled to the central control system 120 via network 116.

The central control system 120 also illustratively receives a number of inputs and outputs for communicating information externally. For interface with a user or operator, central control system 120 includes a display 128 and one or more user input devices 130 (e.g., a keyboard, a mouse, a trackball, a joystick, a touch pad, and/or a microphone, among others).

For additional storage, central control system 120 may also include one or more mass storage devices 132, e.g., a floppy or other removable disk drive, a hard disk, a direct access storage device (DASD), an optical drive (e.g., CD drive, a DVD drive, etc.) and/or a tape drive among others. Furthermore, central control system 120 may include and interface with one or more networks 140 (e.g., a LAN, a WAN, a wireless network, and/or the Internet, amongst others) to permit the communication of the information with other computers coupled to the network. It should be appreciated that the central control system 120 may include suitable analog and/or digital interfaces between processor 122 and each of the other components of the central control system 120 as known in the art.

Central control system 120 operates under the control of an operating system (O/S)157, and executes or otherwise relies upon various computer software applications, components, programs, objects, modules, data structures, etc. Illustratively, a plurality of data structures 142 include a customer table 200, a customer transaction table 300, an item information table 400, a customer credit table 500 and a store description table 600. One or more of the data structures 142 may be periodically updated with information from one or more of the input systems 102A-B (e.g., cash register computers and/or store computer systems). Illustratively, a plurality of software/programs for price-guaranteeing an item purchased using a department store credit card may be loaded in memory 124, including a purchase program 144, a price matching program 146, a scanner error detection batch program 148, and a price-guarantee batch program 150.

Moreover, various applications, components, programs, objects, modules, etc., may also execute on one or more processors in another computer coupled to the central control system 120 via a network 116, in a distributed or client-server computing environment, whereby the processing required to implement the functions of a computer program may be allocated to multiple computers over the network.

Those skilled in the art will recognize that the exemplary environments illustrated in FIG. 1 are not intended to limit the present invention. Indeed, those skilled in the art will recognize that other alternate hardware and/or software environments may be used without departing from the scope of the invention.

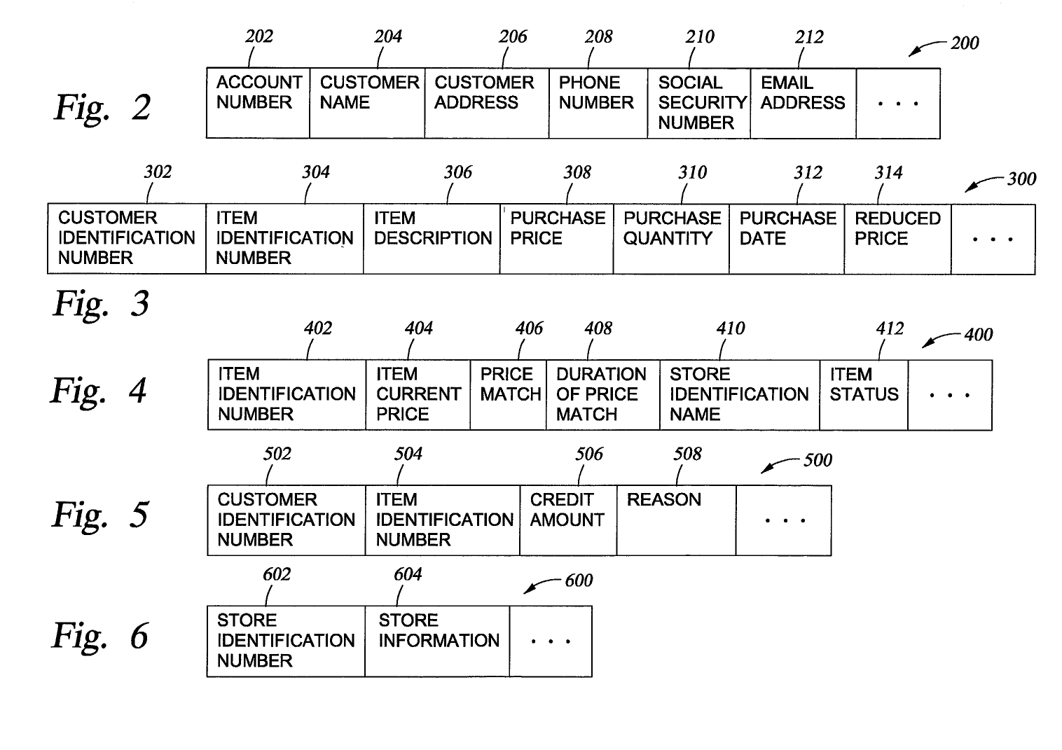

FIGS. 2-6 depict embodiments of the data structures 142. Each data structure is organized as a plurality of rows and columns. The columns designate a particular category of information while each row comprises a record in the data structure. For simplicity only one row/record of each data structure is shown. However, it is understood that the data structures may each comprise a plurality of rows/records.

FIG. 2 illustrates one embodiment of a customer table 200 containing customer records. Each customer record comprises a plurality of customer information entries, such as a customer account number entry 202, a customer name entry 204, a customer address entry 206, a customer phone number entry 208, customer social security number entry 210, customer email address entry 212, and entries for other information that the credit card company may have regarding the customer and/or account. In one embodiment, the customer information contained in the customer table 200 may be compiled from information previously provided by the customers in the credit card company's databases. The customer account number entry 202 contains unique credit card account numbers for each customer and may be used as the primary key (e.g., for identification or sorting of records) to the customer table. The customer name entry 204 contains each customer's name. The customer address entry 206 contains mailing or billing addresses for each customer. The customer phone number entry 208 contains home and/or business numbers for each customer. The customer social security number entry 210 contains each customer's social security number, which may also be used as the primary key to the customer table. The customer email address entry 212 contains one or more email addresses for each customer, which may be utilized for electronically communicating with the customer. For example, the customer may be notified by email periodically if the customer's account has been given a low price guarantee credit as discussed below.

FIG. 3 illustrates one embodiment of a customer transaction table 300 containing customer transaction records. Each customer transaction record comprises a plurality of transaction information entries, such as a customer identification number entry 302, an item identification number entry 304, an item description entry 306, a purchase price entry 308, a purchased item quantity entry 310, a purchase date entry 312, a reduced price entry 314, and entries for other transaction information that the credit card company may require regarding the transactions. In one embodiment, the information contained in the customer transaction table 300 may be provided by the cash register computers 102A or the store central computers 102B as each purchase transaction is reported to central control system 120. The customer identification number entry 302 contains a unique number for identifying the customer, such as the customer's credit card account number (e.g., entry 202) or the customer's social security number (e.g., entry 210). The item identification number entry 304 contains a unique product identification number, such as a Universal Product Code (UPC) number and an inventory number used by a particular store or a chain of stores. The item description entry 306 contains a brief description of the product. The purchase price entry 308 contains the unit price of the product as purchased by the customer. The item quantity entry 310 contains the quantity of the purchased product. The purchase date entry 312 contains the date of the purchase transaction. The reduced price entry 314 contains the price of the item after price matching and/or price guarantees have been processed.

FIG. 4 illustrates one embodiment of an item information table 400 containing item information records. Each item information record comprises a plurality of item information entries, such as an item identification number entry 402, an item current price entry 404, a price match entry 406, a price match duration entry 408, a store identification number entry 410, an item status entry 412 and other information related to price reduction of an item/product. In one embodiment, the item information entries are updated periodically in the central control system corresponding to periodic sales and/or promotions offered by the department store. The item identification number entry 402 contains a unique product identification number, such as a Universal Product Code (UPC) number and an inventory number used by a particular store or a chain of stores. The item current price entry 404 contains the current store price for the item. The price match entry 406 contains the price of the item offered by a competitor store. The price match duration entry 408 contains the effective dates or the number of days for which the item will remain at the matching price at the competitor store if the item is on sale at the competitor store for a limited time period. For a permanent price reduction of an item at the competitor store, a pre-designated maximum number may be utilized for entry 408, or alternatively, entry 408 may be left blank. The store identification number entry 410 contains the identification number of the competitor store having the sale or lower price for the item. The item status entry 412 contains an indication of the item status, for example, a regularly stocked item, a discontinued item, or a clearance item.

FIG. 5 illustrates one embodiment of a customer credit table 500 containing customer credit records. Each customer credit record comprises a plurality of credit information entries, such as a customer identification number entry 502, an item identification number entry 504, a credit amount entry 506, and a reason entry 508. Other entries, such as an item description entry, a purchase price entry, and an item quantity entry, may also be included in the credit table 500. The customer identification number entry 502 contains a unique number for identifying the customer, such as the customer's credit card account number (e.g., entry 202 in Table 2). For example, the customer identification number entry 502 contains the customer's department store credit card account number which will receive a price guarantee credit. The item identification number entry 504 contains a unique product identification number, such as a Universal Product Code (UPC) number and an inventory number used by a particular store or a chain of stores. The credit amount entry 506 contains the amount credited to the customer's account. The reason entry 508 contains an explanation for the price guarantee credit. The explanation may include a short phrase and/or a code for indicating the reason for the credit. For example, in one embodiment, a first code may represent a price guarantee credit for a sale price or a price reduction from the same department store, and a second code may represent a price match credit for matching a sale price or a price reduction from another store. Another code may represent a credit for a scanner error.

FIG. 6 illustrates one embodiment of a store table 600 containing store description records. Each store description record comprises a plurality of store description entries, such as a store identification number entry 602 and a store information entry 604. The store identification number entry 602 contains a unique number or identifier for each store within one enterprise and each competitor store outside of the one enterprise. For example, each store in a chain of department stores is assigned a unique store identification number, and each competitor store (or chain of stores) is assigned a unique store identification number. The store information entry 604 contain information pertaining to each store and may include a variety of data which may require a plurality of additional files or data structures to store the files/data. For example, the store information entry 604 may include data regarding the number of price matches made by the enterprise, competitive information on categories of item for price matching, number of days and times of the year for price matching, and other information related to each store's performance. The information contained in the store information entry 604 may be utilized to an enterprise's competitive advantage.

FIG. 7 is a flow diagram illustrating a method 700 for handling purchases at a cash register. In one embodiment, method 700 illustrates the execution of the purchase program 144 at the cash register computer 102A. Method 700 starts at step 702 and performs initialization steps at 705. The initialization steps may comprise resetting a cash register computer 102A, and/or entering a salesperson activation code into the cash register computer. Upon completion of normal initialization steps, method 700 proceeds to 710 where the cash register waits for an event. At step 715, the event is received, and at step 720, the method 700 determines whether the event is a purchase event. If the event is not a purchase event, method 700 proceeds to step 725 to process the non-purchase event, and after handling the non-purchase event, the method 700 returns to step 710 to again wait on another event.

Referring back to step 720, if the event is a purchase event, then method 700 proceeds to step 730 to determine whether the department store credit card is being used for purchasing the items. If the department store credit card is not used for purchasing the items, the purchase event is processed normally as step 745, and after handling the purchase event normally, the method 700 returns to step 710 to again wait on another event. If the department store credit card is being used for purchasing the items at step 730, method 700 proceeds to process each purchased item through the loop defined by step 735 and step 740. For each item purchased, an entry is added to the customer transaction table 300 at step 740. After all items being purchased have been added to the customer transaction table 300, the remaining tasks of the purchase event are completed in step 750, and the method 700 returns to step 710 to again wait on another event.

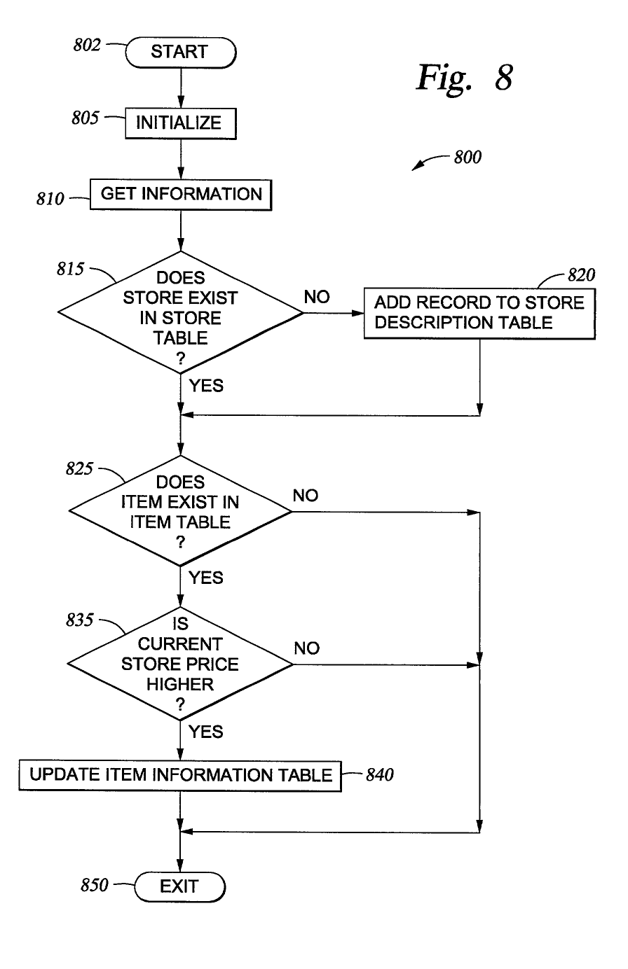

FIG. 8 is a flow diagram illustrating a method 800 for updating and adding records to the store description table 600 and the item information table 400. In one embodiment, method 800 illustrates the execution of a portion of the price-matching program 146. When a sales person is handling a customer request at the cash register computer 102A to price match an item found at another store, the method 800 is triggered and starts at step 802. Initialization of the program is performed at step 805, and then information regarding the price matching request may be entered by the sale person and stored into temporary memory on the cash register computer 102A. In one embodiment, the sales person is prompted by the cash register computer 102A to enter at least the competitor store name or identification number and the item identification number for the item requested to be price matched. It is contemplated that the information provided can take on many forms and may include, but is not limited to, the competitor store name, item name, item description, item price, and other information regarding the sales promotion or price reduction of the item at the competitor store.

Method 800 then determines at step 815 from the temporarily stored information whether a record for the competitor store exists in the store description table 600. If a record for the competitor store does not exist in the store description table 600, a record for the competitor store is added to the store description table 600 at step 820, and then method 800 proceeds to step 825. In one embodiment, the sales person is prompted by the cash register computer 102A to enter store information for the added record in the store description table 600. Referring back to step 815, if a record already exists in the store description table 600, then method 800 proceeds to step 825 to determine whether a record for the item exists in the item information table 400. If a record for the item does not exist in the item information table 400, then the store does not regularly stock the item (e.g., discontinued items and clearance items) and does not need to price match the competitor's price. The method 800 then exits at step 850.

Referring back to step 825, if a record for the item already exists in the item information table 400, then method 800 proceeds to step 835 to determine whether the item price-matching price (i.e., the item price at the competitor store at which the customer is requesting a price match) is lower than the item current price in the item current price entry 404 in item information table 400. If the item price-matching price is not lower than the item current price, then method 800 exits. If the item current price is higher than the item price-matching price, then the item record in the item information table 400 is updated to reflect the new price at step 840. In one embodiment, the salesperson may be prompted by the cash register computer 102A to enter additional item information (e.g., price match entry 406, duration of price match 408, and store identification number 410) to update the record in the item information table 400. After the item information table 400 has been updated, if necessary, the method 800 exits at step 850, and the salesperson may continue to complete processing of the price matching request at the cash register computer 102A-B.

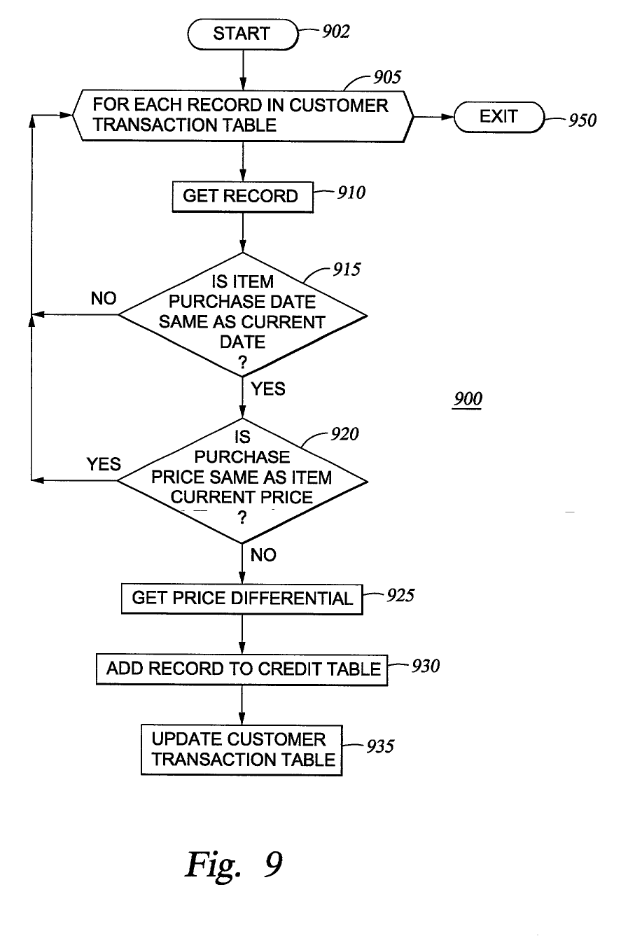

FIG. 9 is a flow diagram illustrating a method 900 for determining whether any scanner errors occurred for items purchased by customers using the department store credit card. Method 900 may be performed as a nightly batch program, and in one embodiment, method 900 illustrates the execution of the scanner error detection batch program 148. Method 900 begins at step 902 and proceeds to step 905 to process each record in the customer transaction table 300. At step 910, one record from the customer transaction table 300 is read and loaded into the program. At step 915, the date of program execution is compared to the item purchase date (in entry 312) for the record in the customer transaction table 300 to determine whether the dates are the same. If the date of program execution is not the same as the item purchase date for the record in the customer transaction table 300, the record does not pertain to possible errors occurring during the same day, and method 900 loops back to step 905 to process the next record.

If the date of program execution is equivalent to the item purchase date for the record in the customer transaction table 300, then processing continues to step 920 to determined whether the item purchase price 308 in the customer transaction table 300 is equivalent to the item current price 404 found in the item information table 400. If the item purchase price 308 in the customer transaction table 300 is equivalent to the item current price 404, then no scanner error occurred for the item purchased, and method 900 loops back to step 905 to process the next record. If the item purchase price 308 in the customer transaction table 300 is not the same as the item current price 404, then a scanner error occurred for the item purchased, and method 900 proceeds to step 925 to determine the difference in prices. After determining the price differential at step 925, a record is added to the customer credit table 500 at step 930 for the customer account to indicate the credit given for the price differential. The reason entry 508 in the customer credit table 500 is updated at step 935 to reflect a scanner error. Method 900 then proceeds to update the customer transaction table 300 by setting the reduced price entry 327 the same as the current store price. After updating all tables, method 900 returns to process more records at step 905. After processing all records, method 900 exits at step 950.

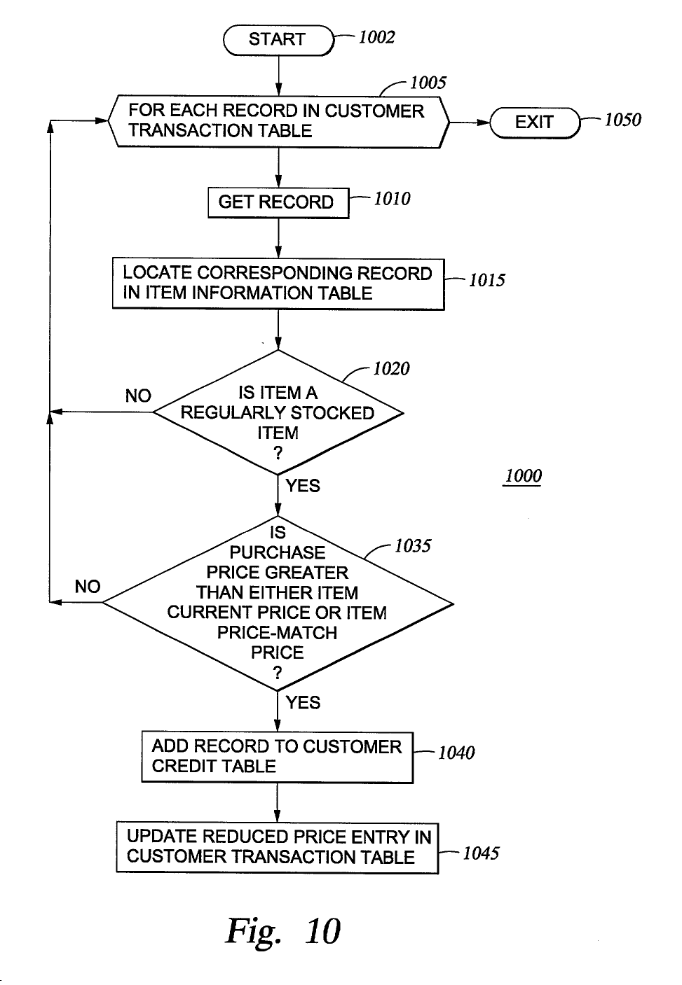

FIG. 10 is a flow diagram illustrating a method 1000 for determining price guarantee credits for items purchased by customers using the department store credit card. Method 1000 may be performed as a nightly batch program, and in one embodiment, method 1000 illustrates the execution of the price-guarantee batch program 150. Method 1000 begins at step 1002 and proceeds to step 1005 where a loop is set up to process records in the customer transaction table 300. At step 1010, one record from the customer transaction table 300 is loaded into the program, and at step 1015, the corresponding item record in the item information table 400 is found and stored in temporary memory. The method 1000 then proceeds to step 1020 and check item status entry 412 to determined whether the item is a regularly stocked item (e.g., not a discontinued item and not a clearance item). If the item is a discontinued or clearance item, then method 1000 returns to step 1005 to process the next record. If the item is a regularly stocked item, then the item purchase price 308 in the customer transaction table 300 is compared to the item current price 404 and the item price-match price 406 in the item information table 400 at step 1035. If the item purchase price 308 is not higher than either the item current price 404 or the item price-match price 406, then method 1000 returns to step 1005 to process the next record. If the item purchase price 308 is higher than either the item current price 404 or the item price-match price 406, then a record is added to the customer credit table 500 to reflect the price differential between the item purchase price and either the item current price or the item price-match price (i.e., the greater price differential) at step 1040. The reason entry 508 in the newly added record in the customer credit table 500 is updated to reflect the reason for the credit as a current sale price or as a price-matching price. Then, the record in the customer transaction table 300 is updated at step 1045 to reflect the lower price in the reduced price entry 314, and then method 1000 returns to step 1005 to process the next record. After all records have been processed, method 1000 exits at step 1050.

The above described embodiments may by modified to perform a method for determining and notifying customers about potential price guarantee credits for items purchased by customers using credit cards other than the department store credit card. In one embodiment, the department store central control system may track items purchased by customers using credit cards other than the department store credit card and notify the customers about potential price guarantee credits that the customers may receive if the department store credit card were used. In such case, transaction data would be stored for all credit card purchases rather than just for department store card purchases, and each item purchased using a credit card is stored in a credit card transaction table (similar to steps 735 and 740 in FIG. 7). Also, instead of crediting the customer's department store credit card account as in step 1040 in FIG. 10, the department store may send an email or an electronic message to the customer regarding the potential savings for using the department store credit card. In another embodiment, the department store may request the customer to transfer a balance from the customer's credit card account which was used to purchase the items, and in return, the department store credits the amount of the potential price guarantee credits to the customer's department store credit card account. This price guarantee credit may be applied directly as credit to the customer's account, or alternatively, as credit toward future purchases charged to the department store credit card.

While the foregoing is directed to embodiments of the present invention, other and further embodiments of the invention may be devised without departing from the basic scope thereof, and the scope thereof is determined by the claims that follow.

What is claimed is:

1. A method for price-guaranteeing an item purchased by a customer, comprising:
receiving, by a central computer system, transaction data from a cash register computer system, the transaction data including an item identification number and an item purchase price;
comparing the item purchase price to a comparison price comprising at least one of an item current price and an item match price; and
if the item purchase price is higher than the comparison price, crediting an amount to a credit card account of the customer.

2. The method of claim 1, wherein the credit card account is a department store credit card account.

3. The method of claim 1, wherein the amount represents a price differential between the item purchase price and the comparison price.

4. The method of claim 1, wherein the transaction data includes one or more information selected from a customer identification number, an item description, a quantity of item purchased and a purchased date.

5. The method of claim 1, wherein the step of comparing is periodically performed.

6. The method of claim 1, further comprising:
receiving, by the central computer system, price matching data from the cash register computer system, the price matching data including at least one of an item identification number, the item match price, an item sale start date, an item sale duration, and a competitor store identification; and
storing price matching data into a data storage device of the central computer system.

7. The method of claim 1, further comprising:
providing a reason for crediting the credit card account of the customer.

8. The method of claim 1, wherein the transaction data further includes an item purchase date.

9. The method of claim 8, further comprising:
comparing the item purchase date to a current date;
if the item purchase date is the same as the current date, comparing the item purchase price to the item current price to determine whether a scanner error occurred; and
if a scanner error occurred, crediting a price differential to the credit card account of the customer.

10. The method of claim 8, further comprising:
comparing the item purchase date to a current date; and
crediting the amount only if the current date is within a price-guarantee period from the item purchase date.

11. The method of claim 1, further comprising:
notifying the customer of potential credits in using a department store credit card instead of crediting an amount to a credit card account of the customer.

12. The method of claim 1, wherein the amount is credited to a department store credit card account of the customer after the customer transfers a balance from another credit card account to the department store credit card account.

13. A signal bearing medium, comprising a program which, when executed by a processor, performs operations for price-guaranteeing an item purchased by a customer, the operations comprising:
receiving, by a central computer system, transaction data from a cash register computer system, the transaction data including an item identification number and an item purchase price;
comparing the item purchase price to a comparison price comprising at least one of an item current price and an item match price; and
if the item purchase price is higher than the comparison price, crediting an amount to a credit card account of the customer.

14. The signal bearing medium of claim 13, wherein the amount represents a price differential between the item purchase price and the comparison price.

15. The signal bearing medium of claim 13, wherein the transaction data includes one or more information selected from a customer identification number, an item description, a quantity of item purchased and a purchased date.

16. The signal bearing medium of claim 13, wherein the step of comparing is periodically performed.

17. The signal bearing medium of claim 13, wherein the operations further comprise providing a reason for crediting the credit card account of the customer.

18. The signal bearing medium of claim 13, wherein the operations further comprise:
receiving, by the central computer system, price matching data from the cash register computer system, the price matching data including at least one of an item identification number, the item match price, an item sale start date, an item sale duration, and a competitor store identification; and
storing price matching data into a data storage device of the central computer system.

19. The signal bearing medium of claim 13, wherein the transaction data further includes an item purchase date.

20. The signal bearing medium of claim 19, wherein the operations further comprise:
comparing the item purchase date to a current date;
if the item purchase date is the same as the current date, comparing the item purchase price to the item current price to determine whether a scanner error occurred; and
if a scanner error occurred, crediting a price differential to the credit card account of the customer.

21. The signal bearing medium of claim 13, wherein the operations further comprise:
comparing the item purchase date to a current date; and
crediting the amount only if the current date is within a price-guarantee period from the item purchase date.

22. An apparatus for price-guaranteeing an item purchased by a customer, comprising:
a central computer system having a processor, a memory and one or more storage devices for storing data connected to the processor, wherein the processor is configured to:
receive transaction data from a cash register computer system, the transaction data including an item identification number and an item purchase price;
compare the item purchase price to a comparison price comprising at least one of an item current price and an item match price; and
if the item purchase price is higher than the comparison price, credit an amount to a credit card account of the customer.

23. The apparatus of claim 22, wherein the central computer system is a department store credit card computer system.

24. The apparatus of claim 22, wherein the processor is further configured to periodically compare the item purchase price to the comparison price.

25. The apparatus of claim 22, wherein the processor is further configured to:
receive price matching data from the cash register computer system, the price matching data including one or more information selected from an item identification number, the item match price, an item sale start date, an item sale duration, and a competitor store identification; and
store price matching data into a data storage device of the central computer system.

26. The apparatus of claim 22, wherein the processor is further configured to provide a reason for crediting the credit card account of the customer.

27. The apparatus of claim 22, wherein the processor is further configured to
receive transaction data including an item purchase date;
compare the item purchase date to a current date;
if the item purchase date is the same as the current date, compare the item purchase price to the item current price to determine whether a scanner error occurred; and
if a scanner error occurred, credit a price differential to the credit card account of the customer.

28. The apparatus of claim 22, wherein the processor is further configured to:
receive transaction data including an item purchase date;
compare the item purchase date to a current date; and
credit the amount only if the current date is within a price-guarantee period from the item purchase date.
